(19) United States
(12) Patent Application Publication
(10) Pub. No.: US 2026/0017785 A1
(43) Pub. Date: Jan. 15, 2026

(54) IRIS OCCLUSION ANALYSIS

(71) Applicant: Tencent Technology (Shenzhen) Company Limited, Shenzhen (CN)

(72) Inventors: Jun WANG, Shenzhen (CN); Jinkun HOU, Shenzhen (CN); Runzeng GUO, Shenzhen (CN); Shaoming WANG, Shenzhen (CN)

(73) Assignee: Tencent Technology (Shenzhen) Company Limited, Shenzhen, GD (CN)

(21) Appl. No.: 19/331,995

(22) Filed: Sep. 17, 2025

Related U.S. Application Data
(63) Continuation of application No. PCT/CN2024/096082, filed on May 29, 2024.

(30) Foreign Application Priority Data
Jul. 28, 2023 (CN) 202310949785.6

(51) Int. Cl. G06T 7/00; G06V 40/18

(52) U.S. Cl. CPC G06T 7/0012; G06V 40/193; G06T 2207/30041

(57) ABSTRACT

In a method for iris occlusion analysis, key point prediction is performed on an eye image of a target object to obtain a plurality of iris boundary key points and a plurality of eyelid boundary key points. Contour fitting is performed on the plurality of iris boundary key points based on an iris contour shape condition to obtain a predicted iris area. An eyelid boundary formed by the plurality of eyelid boundary key points is determined. The iris occlusion analysis is performed on the target object based on a relative positional relationship between the predicted iris area and an area formed by the eyelid boundary to obtain an iris occlusion analysis result.

### RELATED APPLICATIONS

The present application is a continuation of International Application No. PCT/CN2024/096082, filed on May 29, 2024, which claims priority to Chinese Patent Application No. 202310949785.6, filed on Jul. 28, 2023. The entire disclosures of the prior applications are hereby incorporated by reference.

### FIELD OF THE TECHNOLOGY

This application relates to the field of computer technologies, including an iris occlusion analysis method.

### BACKGROUND OF THE DISCLOSURE

An iris is an annular area located between a black pupil and white sclera on a surface of a human eye. Each iris has unique features. Feature information of the iris in the eye may be employed to achieve a purpose of identity authentication, and is applicable to an identity authentication technology in information security.

However, in an actual application process, in a scenario of iris recognition, due to different eye sizes of users, there may be different degrees of occlusion by eyelids, and it is necessary to determine a degree of iris occlusion by the eyelids, to ensure an iris recognition effect. Algorithms for determining the iris occlusion in the related art mainly determine the iris occlusion by performing semantic segmentation on the eyelids and the iris. However, interference factors such as an eyelid shadow and eyelashes may cause problems of relatively low semantic segmentation accuracy and a relatively low processing speed.

### SUMMARY

An aspect of this disclosure provides an iris occlusion analysis method, an iris occlusion analysis apparatus, and a non-transitory computer-readable storage medium.

An aspect of this disclosure provides a method for iris occlusion analysis. In the method, key point prediction is performed on an eye image of a target object to obtain a plurality of iris boundary key points and a plurality of eyelid boundary key points. Contour fitting is performed on the plurality of iris boundary key points based on an iris contour shape condition to obtain a predicted iris area. An eyelid boundary formed by the plurality of eyelid boundary key points is determined. The iris occlusion analysis is performed on the target object based on a relative positional relationship between the predicted iris area and an area formed by the eyelid boundary to obtain an iris occlusion analysis result.

An aspect of this disclosure provides an iris occlusion analysis apparatus. The apparatus includes processing circuitry configured to perform key point prediction on an eye image of a target object to obtain a plurality of iris boundary key points and a plurality of eyelid boundary key points. The processing circuitry is configured to perform contour fitting on the plurality of iris boundary key points based on an iris contour shape condition to obtain a predicted iris area. The processing circuitry is configured to determine an eyelid boundary formed by the plurality of eyelid boundary key points. The processing circuitry is configured to perform iris occlusion analysis on the target object based on a relative positional relationship between the predicted iris area and an area formed by the eyelid boundary to obtain an iris occlusion analysis result.

An iris occlusion analysis method is performed by the computer device, and includes: performing key point prediction on an eye image of a target object, to obtain a plurality of iris boundary key points and a plurality of eyelid boundary key points; performing contour fitting on the iris boundary key points according to an iris contour shape condition, to obtain a predicted iris area; determining an eyelid boundary formed by the eyelid boundary key points; and performing iris occlusion analysis on the target object based on a relative positional relationship between the predicted iris area and an area formed by the eyelid boundary to obtain an iris occlusion analysis result.

An iris occlusion analysis apparatus is provided. The apparatus includes: a key point prediction module, configured to perform key point prediction on an eye image of a target object, to obtain a plurality of iris boundary key points and a plurality of eyelid boundary key points; a contour fitting module, configured to perform contour fitting on the iris boundary key points according to an iris contour shape condition, to obtain a predicted iris area; a boundary determining module, configured to determine an eyelid boundary formed by the eyelid boundary key points; and an occlusion analysis module, configured to perform iris occlusion analysis on the target object based on a relative positional relationship between the predicted iris area and an area formed by the eyelid boundary to obtain an iris occlusion analysis result.

A computer device includes a memory and one or more processors, where the memory has computer-readable instructions stored therein, and the computer-readable instructions, when executed by the one or more processors, cause the one or more processors to perform operations of the foregoing iris occlusion analysis method.

An aspect of this disclosure provides a non-transitory computer-readable storage medium, having computer-executable instructions stored therein, the computer-executable instructions, when executed by a processor, cause the processor to implement the foregoing iris occlusion analysis method.

A computer program product or a computer program is provided. The computer program product or the computer program includes computer-readable instructions, the computer-readable instructions are stored in a computer-readable storage medium, one or more processors of a computer device read the computer-readable instructions from the computer-readable storage medium, and the one or more processors execute the computer-readable instructions, causing the computer device to perform operations of the foregoing iris occlusion analysis method.

Details of one or more aspects of this disclosure are provided in the accompanying drawings and descriptions below. Other features, objectives, and advantages of this disclosure become apparent from the specification, the accompanying drawings, and the claims.

### BRIEF DESCRIPTION OF THE DRAWINGS

FIG. 1 is a diagram of an application environment of an iris occlusion analysis method according to an aspect.

FIG. 2 is a schematic flowchart of an iris occlusion analysis method according to an aspect.

FIG. 3 is a schematic diagram of various key points in an iris occlusion analysis method according to an aspect.

FIG. 4 is a schematic diagram of a boundary determined based on key points according to an aspect.

FIG. 5 is a schematic diagram of an iris not occluded by eyelids according to an aspect.

FIG. 6 is a schematic diagram of an iris partially occluded by eyelids according to an aspect.

FIG. 7 is a schematic structural diagram of a key point prediction model according to an aspect.

FIG. 8 is a schematic diagram of a regression process of a key point prediction model according to an aspect.

FIG. 9 is a schematic flowchart of an iris occlusion analysis method according to an aspect.

FIG. 10 is a structural block diagram of an iris occlusion analysis apparatus according to an aspect.

FIG. 11 is a diagram of an internal structure of a computer device according to an aspect.

FIG. 12 is a diagram of an internal structure of a computer device according to an aspect.

### DETAILED DESCRIPTION

To make the objectives, technical solutions, and advantages of this disclosure clearer, the following further describes examples of aspects of this disclosure in further detail with reference to the accompanying drawings. It is to be understood that the aspects described herein are used to explain this disclosure, and not to limit this disclosure. The descriptions of the terms are provided as examples only and are not intended to limit the scope of the disclosure.

Solutions provided by the aspects of this disclosure relate to technologies such as computer vision of artificial intelligence. Eye key points of a target object are positioned in an eye image to determine a predicted iris area and an eyelid boundary in the eye image, whereby an iris occlusion analysis is performed on the target object, to obtain an iris occlusion analysis result, and then whether iris recognition may be performed on the target object, or whether it is necessary to prompt the target object to open eyes for image acquisition and analysis again is determined based on the iris occlusion analysis result.

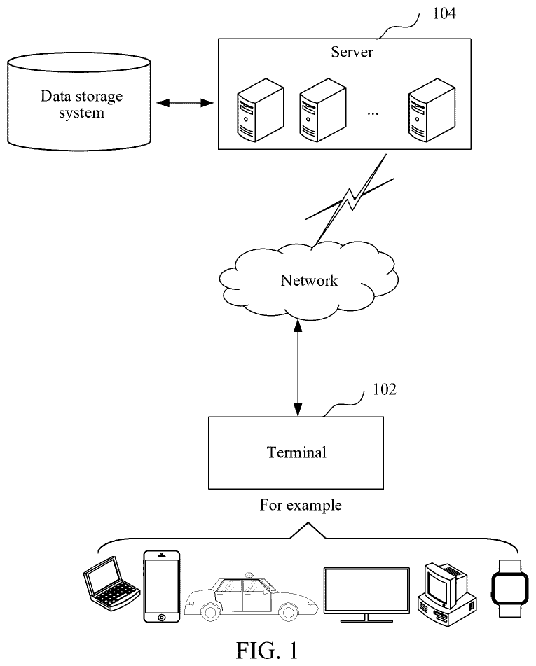

An iris occlusion analysis method provided by an aspect of this disclosure may be applied to an application environment shown in FIG. 1. A terminal 102 communicates with a server 104 over a network. A data storage system may store data that needs to be processed by the server 104. The data storage system may be integrated onto the server 104, or arranged on cloud or another server. The terminal 102 may transmit an eye image of a target object to the server 104. The server 104 performs key point prediction on the eye image of the target object, to obtain a plurality of iris boundary key points and a plurality of eyelid boundary key points, performs contour fitting on the iris boundary key points according to an iris contour shape condition, to obtain a predicted iris area, determines an eyelid boundary formed by the eyelid boundary key points, performs iris occlusion analysis on the target object based on a relative positional relationship between the predicted iris area and an area formed by the eyelid boundary, to obtain an iris occlusion analysis result, and transmits the iris occlusion analysis result to the terminal 102. In another aspect, the iris occlusion analysis method may alternatively be performed by the terminal 102 alone or performed by the server 104 alone.

The terminal 102 may be, but is not limited to, various desktop computers, notebook computers, smart-phones, tablet computers, Internet of Things devices, and portable wearable devices. The Internet of Things device may be a smart speaker, a smart television, a smart air conditioner, a smart in-vehicle device, or the like. The portable wearable device may be a smart watch, a smart band, a head-mounted device, or the like. The server 104 may be an independent server or a server cluster including a plurality of servers. A client of a target application may be installed in the terminal 102. The target application may be any application capable of providing an image processing function. Typically, the application is an image processing application, and this type of application provides a function of analyzing content of an inputted image. Certainly, besides the image processing applications, an image processing service may alternatively be provided in another type of application, such as a news application, a shopping application, a social application, an interactive entertainment application, a browser application, a content sharing application, a virtual reality (VR) application, or an augmented reality (AR) application. This is not limited in this aspect of this disclosure. In addition, for different applications, types of images processed by the applications may be different, and the corresponding functions may be different. This can be configured in advance according to actual needs. This is not limited in this aspect of this disclosure. In some aspects, the client running the foregoing application in the terminal device 102 may implement the iris occlusion analysis for the eye image.

In an example, a key point prediction process is performed in a key point prediction model, and the key point prediction model is run on a computer device. For example, an execution body of operations of the method provided by this disclosure may be a computer device, and the computer device may be any electronic device having data storage and processing capabilities. For example, the computer device may be the server 104 in FIG. 1, may be the terminal device 102 in FIG. 1, or may be another device other than the terminal 102 and the server 104.

With increasing social awareness of information security, iris recognition has a wider application prospect in actual application scenarios such as payment and identity authentication. In an aspect, using an example in which the terminal is a VR device, the target object wears the VR device. The VR device may acquire an eye image of a target object and upload the eye image to a server. The server performs key point prediction on the eye image of the target object, to obtain a plurality of iris boundary key points and a plurality of eyelid boundary key points, performs contour fitting on the iris boundary key points according to an iris contour shape condition, to obtain a predicted iris area, determines an eyelid boundary formed by the eyelid boundary key points, performs iris occlusion analysis on the target object based on a relative positional relationship between the predicted iris area and an area formed by the eyelid boundary, to obtain an iris occlusion analysis result, and transmits the iris occlusion analysis result to the VR device when the iris occlusion analysis result is that an occlusion ratio exceeds a maximum tolerated iris occlusion proportion, causing the VR device to transmit an eye-opening prompt message to the target object to re-acquire the eye image for analysis. The server extracts an iris feature from the predicted iris area when the iris occlusion analysis result is that an occlusion proportion is less than or equal to a maximum tolerance proportion threshold of iris occlusion, and performs iris recognition processing on the target object based on the iris feature, to obtain an iris recognition result.

In another aspect, the iris occlusion analysis method may further be applied to a traffic scenario, an education scenario, or the like. For example, in a driving process of a driver in the traffic scenario, an iris occlusion analysis is performed on a driver by employing the foregoing iris occlusion analysis method, whether the driver is experiencing fatigue is determined according to an iris occlusion analysis result, and when the possible fatigue driving of the driver is detected, a prompt message is timely transmitted to the driver. For another example, during the class in the education scenario, an iris occlusion analysis is performed on a student by employing the foregoing iris occlusion analysis method, whether the student is dozing off in class is determined according to an iris occlusion analysis result, and a prompt message is timely transmitted to the student when it is found that the student may be dozing off.

In some of the aspects, the VR device is integrated with an algorithm for performing the iris occlusion analysis and has computational power for performing the iris occlusion analysis. After acquiring an eye image of a target object, the VR device performs key point prediction on the eye image of the target object, to obtain a plurality of iris boundary key points and a plurality of eyelid boundary key points, performs contour fitting on the iris boundary key points according to an iris contour shape condition, to obtain a predicted iris area, determines an eyelid boundary formed by the eyelid boundary key points, performs iris occlusion analysis on the target object based on a relative positional relationship between the predicted iris area and an area formed by the eyelid boundary, to obtain an iris occlusion analysis result, and transmits an eye-opening prompt message to the target object to re-acquire the eye image for analysis when the iris occlusion analysis result is that an occlusion proportion is greater than a maximum tolerance proportion threshold of iris occlusion. The server extracts an iris feature from the predicted iris area when the iris occlusion analysis result is that the occlusion proportion is less than or equal to the maximum tolerance proportion threshold of iris occlusion, and performs iris recognition processing on the target object based on the iris feature, to obtain an iris recognition result.

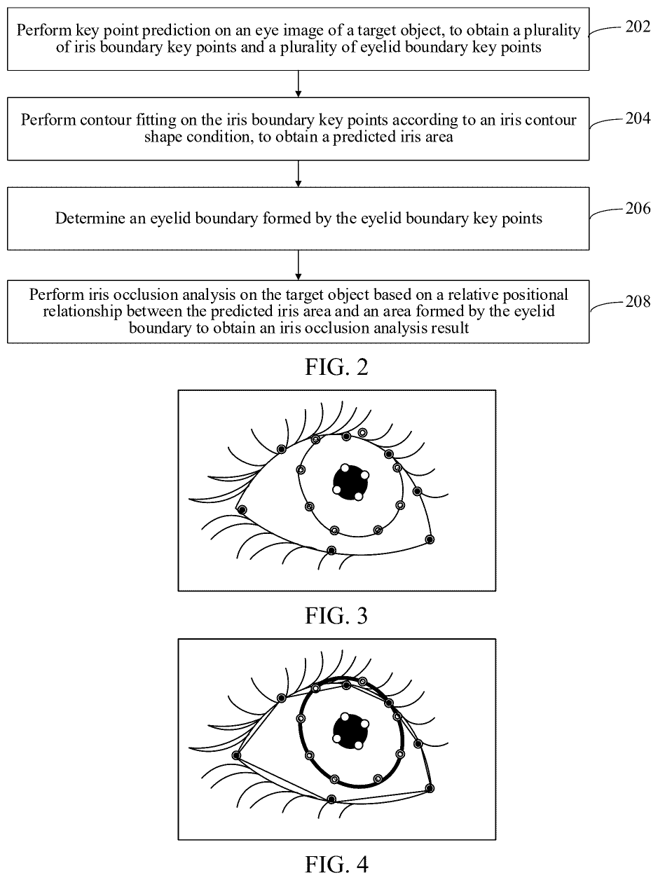

In an aspect, as shown in FIG. 2, an iris occlusion analysis method is provided. An example in which the method is applied to a computer device is used for description. The computer device may be the server in FIG. 1, or may be the terminal with a data processing capability, or may be implemented alternatively by the server and the terminal. The method includes the following operations:

Operation 202: Perform key point prediction on an eye image of a target object, to obtain a plurality of iris boundary key points and a plurality of eyelid boundary key points. For example, key point prediction is performed on an eye image of a target object to obtain a plurality of iris boundary key points and a plurality of eyelid boundary key points.

The target object is an object on which iris occlusion analysis needs to be performed, such as an object whose learning state or driving state is recognized through an iris occlusion degree, or an object whose identity needs to be authenticated by means of iris recognition. The eye image is an image with image content being an eye of the target object. The eye image may be a pre-stored image, or may be an image acquired in real time by an image acquisition apparatus for the target object. The eye image of the target object may be a directly obtained or acquired eye image, or may be an eye image intercepted from a video frame in a video or a dynamic image. For example, when the computer device has an image acquisition function, the computer device may perform image acquisition for the target object, to obtain an eye image. Alternatively, the computer device may acquire a video for the target object, and extract an eye image of the target object from a video frame sequence of the video.

The key point prediction refers to a process of predicting, for a particular portion of an image, a position of a constituent key point of the particular portion in the image. For example, if the particular portion in the eye image includes an iris and eyelids, the key point prediction for the eye image is to predict iris boundary key points and eyelid boundary key points in the eye image.

In some aspects, the key point prediction may be implemented by executing a key point prediction algorithm. For example, the key point prediction may be performed by employing a deep network. A specific prediction process may be to extract features by employing a convolutional neural network (CNN), and then directly perform numerical regression on coordinates of key points by employing a fully-connected layer. For example, the key point prediction algorithm may be implemented by employing a human PoseEstimation via deep neural network (DeepPose network), implemented by employing a multi-task cascaded convolutional network (MTCNN), or implemented by employing a heat map prediction method. A principle of the heat map prediction is to extract a point with a pixel response being greater than a threshold and with a maximum response in a channel, and the coordinates of the point are the coordinates of the key point. In an aspect, using an example in which the key point prediction algorithm is a regression-based DeepPose algorithm, key point prediction may be performed on an eye image of a target object by means of the DeepPose algorithm, to obtain a plurality of iris boundary key points and a plurality of eyelid boundary key points.

Further, a process of predicting the iris boundary key points and the eyelid boundary key points may be implemented by employing a neural network model capable of implementing the key point prediction algorithm. The neural network model may be obtained by training based on a sample eye image with key point marks. Categories of the key points predicted by the key point prediction algorithm may be determined based on a category corresponding to a sample with key point marks.

The iris boundary key points are key points configured for representing a boundary of an area in which an iris is located in an eye. The iris is an annular area located between a black pupil and a white sclera on a surface of a human eye. For example, the iris boundary key points include key points of an outer iris boundary and key points of a pupil boundary, the outer iris boundary is a boundary between the iris and the white sclera, and the pupil boundary is a boundary between the iris and the black pupil.

The eyelid boundary key points are key points configured for representing an eyelid boundary of an eye. Eyelids of the eye include an upper eyelid and a lower eyelid, and the eyelid boundary key points may include upper eyelid boundary key points and lower eyelid boundary key points. A quantity of upper eyelid boundary key points and a quantity of lower eyelid boundary key points may be the same or different.

In a process of performing key point prediction on the eye image, the quantities of the iris boundary key points and eyelid boundary key points that need to be predicted are more than one. For example, the quantities of iris boundary key points and eyelid boundary key points may be preset. For example, the quantity of the iris boundary key points may be set to X, and the quantity of the eyelid boundary key points may be set to Y.

In an application, since the pupil is inherently a circular area, and in a scenario of iris recognition, ambient adaptation causes pupil constriction, an imaging distortion remains relatively small at minor angles. Therefore, the quantity of key points on the pupil boundary may be set to at least three, for example, the quantity of the key points on the pupil boundary may be 4. Since the iris area is larger than the pupil and more susceptible to eyelid occlusion, the quantity of key points on the outer iris boundary may be greater than that on the pupil boundary. For example, the quantity of the key points on the outer iris boundary may be set to 8. Since an upper portion has a larger curvature than that of a lower portion of the eyelid boundary, a quantity of the upper eyelid boundary key points may be greater than a quantity of the lower eyelid boundary key points.

In an aspect, as shown in FIG. 3, a quantity of pupil boundary key points is four, a quantity of outer iris boundary key points is eight, and a quantity of eyelid boundary key points is six. The eyelid boundary key points include two eye corner key points, one lower eyelid boundary key point, and three upper eyelid boundary key points.

Operation 204: Perform contour fitting on the iris boundary key points according to an iris contour shape condition, to obtain a predicted iris area. For example, contour fitting is performed on the plurality of iris boundary key points based on an iris contour shape condition to obtain a predicted iris area.

The iris contour shape condition is configured for defining a boundary contour of a fitted iris area. The iris contour shape condition may include an outer iris boundary shape condition and an inner iris boundary shape condition, and the inner iris boundary shape condition is a pupil boundary shape condition. The outer iris boundary shape condition and the pupil boundary shape condition may be defined as a same boundary shape, or may be defined as different boundary shapes.

The contour fitting refers to a process of fitting a contour boundary line conforming to the iris contour shape condition based on a distribution of iris boundary key points. For different iris contour shape conditions, different contour fitting algorithms may be used for implementation. For example, a circular contour boundary line is obtained by fitting through a circular fitting algorithm. For another example, an elliptical contour boundary line is obtained by fitting through an elliptical fitting algorithm.

The iris contour shape condition may be determined according to an actual eye image acquisition angle and acquisition scenario. For an eye image acquired at a front viewing angle, the iris contour shape condition may be set to a circular contour. For an eye image acquired from multiple angles, the outer iris boundary shape condition in the iris contour shape condition may be set to an elliptical contour, and the pupil boundary shape condition in the iris contour shape condition may be set to a circular contour. The predicted iris area is a theoretically complete iris area in terms of the iris part, and in the eye image, the predicted iris area includes an iris area displayed in the eye image and an iris area occluded by eyelids.

In an aspect, after acquiring an eye image of a target object, a computer device performs key point prediction on the eye image based on a key point prediction algorithm, to obtain a plurality of iris boundary key points, and marks the plurality of iris boundary key points in the eye image or records coordinates of the plurality of iris boundary key points. For the plurality of iris boundary key points, the computer device first acquires a preset iris contour shape condition, performs contour fitting on the iris boundary key points according to the iris contour shape condition, and determines a predicted iris area based on a fitting result.

Operation 206: Determine an eyelid boundary formed by the eyelid boundary key points. For example, an eyelid boundary formed by the plurality of eyelid boundary key points is determined.

The eyelid boundary key points are key points representing an eye border in the eye image. The eyelid boundary is determined by the eyelid boundary key points. The eyelid boundary may be obtained by performing curve fitting on the eyelid boundary key points, or may be obtained by directly connecting the key points based on coordinates of the eyelid boundary key points.

For example, the eyelid boundary key points may be divided into eye corners key points and middle eyelid key points. In a process of determining the eyelid boundary, the middle eyelid key points may be fitted by using the eye corner key points as end points, to obtain the eyelid boundary. The middle eyelid key points may include upper eyelid boundary key points and lower eyelid boundary key points. In a process of determining the eyelid boundary, the upper eyelid boundary key points and the lower eyelid boundary key points may be separately fitted by using the eye corner key points as end points, to obtain an upper eyelid boundary and a lower eyelid boundary, and the eyelid boundary is formed based on the upper eyelid boundary and the lower eyelid boundary.

In an aspect, after acquiring the eye image of the target object, the computer device performs key point prediction on the eye image based on a key point prediction algorithm. While obtaining the plurality of iris boundary key points through prediction, the computer device may further obtain the plurality of eyelid boundary key points through prediction, mark the plurality of eyelid boundary key points in the eye image or record coordinates of the plurality of eyelid boundary key points. For the plurality of eyelid boundary key points, the computer device processes the eyelid boundary key points in a manner such as key point connection or key point fitting, to obtain the eyelid boundary formed by the eyelid boundary key points.

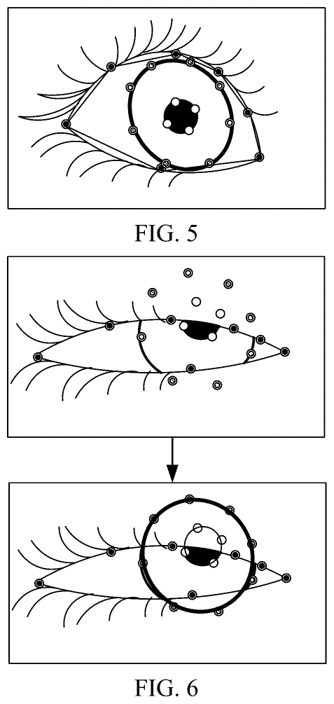

In an aspect, as shown in FIG. 4, predicted key points include four pupil boundary key points, eight outer iris boundary key points, and six eyelid boundary key points. The eyelid boundary key points include two eye corner key points, one lower eyelid boundary key point, and three upper eyelid boundary key points. The computer device fits the four pupil boundary key points into a circular pupil boundary, and fits the eight outer iris boundary key points into an elliptical outer iris boundary. The predicted iris area is determined based on the fitted outer iris boundary and the fitted pupil boundary. Further, the computer device connects the two eye corner key points and the three upper eyelid boundary key points to obtain the upper eyelid boundary, connects the two eye corner key points and the one lower eyelid boundary key point to obtain the lower eyelid boundary, and then determines the eyelid boundary based on the upper eyelid boundary and the lower eyelid boundary.

Operation 208: Perform iris occlusion analysis on the target object based on a relative positional relationship between the predicted iris area and an area formed by the eyelid boundary to obtain an iris occlusion analysis result. For example, iris occlusion analysis is performed on the target object based on a relative positional relationship between the predicted iris area and an area formed by the eyelid boundary to obtain an iris occlusion analysis result.

The area formed by the eyelid boundary is an inner area surrounded by the eyelid boundary, and at least partially coincides with the predicted iris area. The relative positional relationship between the predicted iris area and the area formed by the eyelid boundary includes that the area formed by the eyelid boundary includes the entire predicted iris area, or the area formed by the eyelid boundary includes a part of the predicted iris area. For example, as shown in FIG. 5, when an eye of a target object is in an opened state during acquisition of an eye image, the area formed by the eyelid boundary includes the predicted iris area. For another example, as shown in FIG. 6, when an eye of a target object is in a half-opened state during the acquisition of an eye image, the area formed by the eyelid boundary includes a part of the predicted iris area, and another part of the predicted iris area is covered by eyelids.

The iris occlusion analysis refers to analysis on a degree of iris occlusion by the eyelids. The degree of iris occlusion may be analyzed by setting an occlusion proportion threshold, or may be determined by determining whether a pupil area is occluded by the eyelids. A specific iris occlusion analysis manner may be determined by an analysis requirement for the iris occlusion in an actual scenario. For example, when a learning state of a student or a driving state of a driver is determined, the analysis may be performed by calculating an occlusion proportion threshold; and during identity authentication for a user, the analysis may be performed by determining whether a pupil area is occluded by eyelids.

The iris occlusion analysis result may include a degree of iris occlusion by the eyelids, and may further include whether the eyelids occlude the pupil. In some of the aspects, the computer device may determine an iris occlusion proportion by the eyelids based on the relative positional relationship between the predicted iris area and the area formed by the eyelid boundary, then compare the occlusion proportion with a set occlusion proportion threshold to determine the degree of iris occlusion by the eyelid, and obtain the iris occlusion analysis result. A more accurate occlusion degree analysis result can be obtained according to the iris occlusion proportion by the eyelids, and this may be applicable to a scenario with high requirements on precision of the occlusion degree.

In some other aspects, the computer device may alternatively determine whether the eyelids occlude the pupil based on the relative positional relationship between the predicted iris area and the area formed by the eyelid boundary. If the eyelids occlude the pupil, it indicates that the degree of iris occlusion by the eyelids is relatively high. If the eyelids do not occlude the pupil, it indicates that the degree of iris occlusion by the eyelids is relatively low. The manner for determining whether the eyelids occlude the pupil is simpler, may obtain a determination result quickly, and may be applicable to a scenario with high requirements on an occlusion degree determining speed.

Further, in this disclosure, performing the iris occlusion analysis is to obtain iris information of the target object for identity identification. The eye image of the target object includes the iris information. To protect the iris information of the target object and an identity identification result obtained based on the iris information, data transmission between a device acquiring the eye image of the target object and a device performing iris recognition may be implemented in a data encryption manner.

When the iris occlusion analysis process is implemented by the server, data transmitted by the terminal to the server may be an encrypted eye image. Encryption of the eye image may be implemented in manners such as image segmentation and recombination or key encryption. Image segmentation and recombination refers to a process in which the eye image is segmented into a plurality of image blocks according to a particular rule, and the image blocks are recombined. During transmission of the eye image, the segmented and recombined image is transmitted. After obtaining the segmented and recombined image, the server may restore the plurality of image blocks to the eye image based on an inverse process of image segmentation and recombination performed by the terminal, to further perform subsequent processing, whereby leakage of the iris information included in the eye image of the target object during the transmission process is avoided. Further, after the server performs identity identification on the iris information in the eye image, if specific identity information needs to be fed back to the terminal in an application scenario, during transmission of the identity information, the encryption processing may be performed by using a key, whereby the leakage of the identity information corresponding to the eye image can be avoided to some extent, and a threat posed by the security of the identity information of the target object can be reduced.

When the iris occlusion analysis process is completed by the terminal, the terminal may encrypt the iris information in a process in which the iris occlusion analysis result indicates that iris recognition may be performed on the eye image and the extracted iris information is transmitted to the server for identity identification. The encryption manner may be data block recombination, key encryption, or the like.

According to the foregoing iris occlusion analysis method, the key point prediction is performed on the eye image of the target object, whereby the plurality of iris boundary key points and the plurality of eyelid boundary key points may be directly predicted, the key points in the eye image can be quickly predicted, and further the predicted iris area and the eyelid boundary can be determined based on the key points. The predicted iris area is not just the iris shown in the eye image, but is obtained by performing contour fitting on the iris boundary key points according to the iris contour shape condition, whereby the predicted iris area can be conveniently and quickly determined. The eyelid boundary is formed by the eyelid boundary key points and can accurately express an eyelid position in the eye image. Therefore, the iris occlusion analysis can be performed on the target object based on the relative positional relationship between the predicted iris area and the area formed by the eyelid boundary, to quickly and accurately obtain the iris occlusion analysis result.

In an aspect, the operation of performing key point prediction on an eye image of a target object, to obtain a plurality of iris boundary key points and a plurality of eyelid boundary key points includes:
preliminary key point recognition is performed on the eye image of the target object, to determine initial key points; an eye area in the eye image is determined according to a distribution of the initial key points in the eye image; the eye image is cropped under a cropping condition that an area ratio of the eye area reaches a set ratio threshold, to obtain a target image; and the key point prediction is performed on the target image based on a key point prediction algorithm, to obtain the plurality of iris boundary key points and the plurality of eyelid boundary key points.

The eye image of the target object may be an eye image including an eye of the target object and acquired according to a preset size. The preset size may be an acquisition parameter set by an image acquisition apparatus. A same acquisition parameter is employed for different objects in different scenarios, to obtain the acquired images of a same size. However, an acquisition distance between the target object and the image acquisition apparatus may change with a change of an acquisition scenario, and due to individual difference of different target objects, the acquisition distance between the target object and the image acquisition apparatus may further be different. Therefore, when the key point prediction algorithm performs image processing, an iteration idea is employed to implement key point prediction. In a first stage of the key point prediction algorithm, after an image of a particular size is inputted for a series of convolutional processing through the key point prediction algorithm, finally predicted key point coordinates (xi, yi) are obtained by processing through two full link layers. Since an inputted target size is uncertain, the inputted image of the particular size may lead to a deviation in the final key point prediction due to zooming of the excessively large image. In a second stage of the key point prediction algorithm, the idea of the first stage continues to be reused, and an area surrounding the predicted key point is cropped and enlarged for subsequent more accurate prediction, whereby the final prediction accuracy is improved.

For example, in the first stage, the used key point prediction algorithm is a DeepPose algorithm, and a core idea of the DeepPose algorithm is to transform a key point detection algorithm into a pure mathematical prediction problem. A large number of sample images in which the eye key points in various states are manually marked are learned by employing deep neural networks (DNN), to implement more generalized end-to-end key point prediction.

In an application, the computer device obtains the eye image acquired by the image acquisition apparatus for the target object, and the eye image includes an eye area of the target object. A process of obtaining the eye image includes that the computer device transmits an acquisition instruction to the image acquisition apparatus, to obtain the eye image including the eye of the target object and acquired by the image acquisition apparatus according to the preset size.

In another aspect, the process of obtaining the eye image may alternatively be that the image acquisition apparatus actively triggers eye image acquisition of the target object when detecting that a particular condition is satisfied, and transmits the acquired eye image to the computer device. The image acquisition apparatus may be a device communicating with the computer device over a network, or an apparatus built in the computer device.

In some aspects, taking a VR scenario as an example, the image acquisition apparatus may be an infrared image acquisition apparatus. The infrared image acquisition apparatus acquires broad-spectrum infrared imaging by employing an infrared sensor. Since an iris has unique infrared absorption characteristics, and interference of VR color imaging needs to be avoided in the VR scenario, a superior anti-interference and recognition effect is achieved by employing the infrared image to acquire the iris information.

After obtaining the eye image of the preset size, the computer device first performs preliminary key point recognition on the eye image of the target object based on the key point prediction algorithm, to determine the initial key points. Then, the computer device determines the eye area in the eye image according to distribution data of the initial key points in the eye image, and crops the eye image under the cropping condition that the area ratio of the eye area reaches the set proportion threshold, to obtain the target image whose distribution of the key points satisfies a preset distribution condition. After obtaining the target image, the computer device may perform key point prediction on the target image based on the key point prediction algorithm, to obtain the plurality of iris boundary key points and the plurality of eyelid boundary key points.

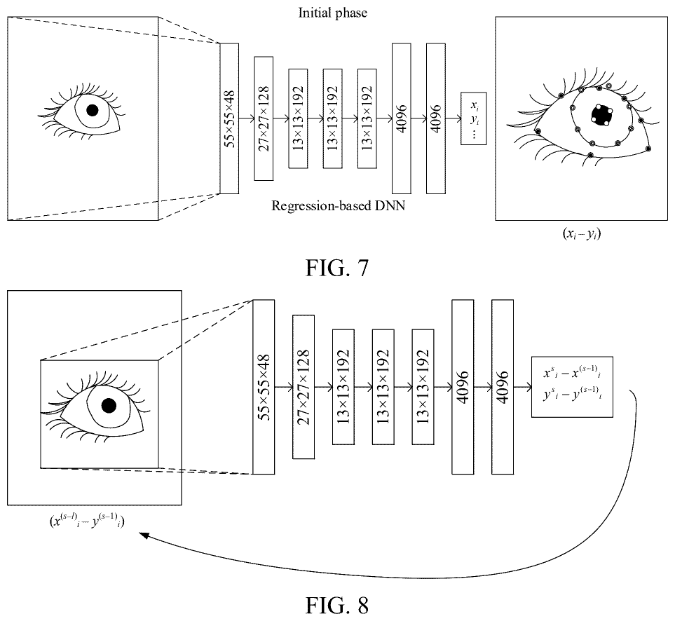

As shown in FIG. 7, an eye image is cropped according to a distribution of initial key points in an eye image, to obtain a target image whose key point distribution satisfies a distribution condition. The target image may be an effect achieved after multiple times of cropping. The cropping is performed each time according to a set proportion, and key point prediction is re-performed on the cropped image, until an area ratio of the eye area in the cropped image reaches a set ratio threshold. The image is used as the target image for prediction to obtain iris boundary key points and eyelid boundary key points.

In this aspect, the key point prediction and image cropping are cyclically performed by employing the key point prediction algorithm, which can optimize a key point prediction result, whereby the predicted iris boundary key points and eyelid boundary key points have relatively high accuracy.

In some aspects, the key point prediction process is implemented by a key point prediction model. A training process of the key point prediction model includes: sample images of an eye in different occlusion states are obtained, iris boundary key points and eyelid boundary key points are marked in the sample images, and a distribution of the marked iris boundary key points in each sample image conforms to the iris contour shape condition; the marked eyelid boundary key points are configured for representing an eyelid boundary in each sample image; and an initial deep neural network model is trained based on the sample images until a model training stopping condition is satisfied, to obtain the key point prediction model configured to perform key point prediction on an eye image.

The key point prediction model may be obtained by training the initial deep neural network model through the sample image carrying key point marks. A manner of marking the key points in the sample image may affect a prediction effect of the trained key point prediction model. Therefore, when performing marking on the sample image, it is necessary to ensure that the distribution of the marked iris boundary key points in the sample image conforms to the iris contour shape condition, and the marked eyelid boundary key points are located on the eyelid boundary, causing the marked eyelid boundary key points to accurately represent the eyelid boundary in the sample image. A manner of marking the key points in the sample image may be implemented based on types of the key points. For example, the iris boundary key points may be selected from an iris contour with a particular shape in the sample image, and the eyelid boundary key points may be directly selected from the eyelid boundary in the sample image.

The initial deep neural network model may be a deep neural network (DNN) model. A structure of the DNN model is shown in FIG. 8, and includes a plurality of convolutional layers and two fully-connected layers. After obtaining the predicted target points from the fully-connected layers, a current image is further cropped based on the predicted target points, to obtain a new image which is processed by the DNN model for target point prediction until a target image with key point distribution satisfying a distribution condition is obtained. Then, the DNN model performs final key point prediction processing on the target image to output a prediction result. In a training process, the DNN model employs supervised training implemented based on the marked key points, to obtain the key point prediction model through training for performing key point prediction processing on the eye image of the target object.

In this aspect, the deep neural network model is used as a model architecture to be trained by taking the sample image in which various key points are marked as a training sample, whereby the key point prediction model obtained through training has an accurate and high-efficient capability for identifying and predicting the key points, and the prediction efficiency for the key points in the eye image is improved.

In some aspects, the eyelid boundary includes an upper eyelid boundary and a lower eyelid boundary. The eyelid boundary key points include eye corner key points located at intersections of the upper eyelid boundary and the lower eyelid boundary, upper eyelid key points located on the upper eyelid boundary, and lower eyelid key points located on the lower eyelid boundary. A quantity of the upper eyelid key points is greater than a quantity of the lower eyelid key points.

The upper eyelid boundary is a boundary line representing a boundary position of an upper eyelid of the target object in the eye image, and the lower eyelid boundary is a boundary line representing a boundary position of a lower eyelid of the target object in the eye image. The intersections of the upper eyelid and the lower eyelid are corners of the eye, key points marked at the corners of the eye are the eye corner key points, key points marked on the upper eyelid boundary are upper eyelid key points, and key points marked on the lower eyelid boundary are lower eyelid key points. A curvature of the upper eyelid boundary is greater than a curvature of the lower eyelid boundary. Therefore, when the eyelid boundary key points are marked, a quantity of the marked upper eyelid key points is greater than a quantity of the lower eyelid key points.

In this aspect, the key points on the eyelid boundary are marked by defining the positions and quantities of the eyelid boundary key points, whereby the key points marked in the sample image can represent the position of the eyelid more accurately; and therefore, the key point prediction model trained based on the sample image in which the key points are marked can perform key point prediction more accurately.

In some aspects, after key point prediction is performed on an eye image of a target object, to obtain eyelid boundary key points, the eyelid boundary in the eye image needs to be determined based on the eyelid boundary key points. The above describes that the eyelid boundary may be implemented by means of curve fitting and connection of key points. The following describes a specific implementation of determining the eyelid boundary in a manner of connecting the key points.

For example, the operation of determining an eyelid boundary formed by the eyelid boundary key points includes:
eye corner key points, upper eyelid key points, and lower eyelid key points are recognized from the eyelid boundary key points; the upper eyelid key points are connected through a first connection line by using the eye corner key points as end points, to obtain an upper eyelid boundary; the lower eyelid key points are connected through a second connection line by using the eye corner key points as the end points, to obtain a lower eyelid boundary; and the eyelid boundary is determined based on the upper eyelid boundary and the lower eyelid boundary.

The eyelid boundary key points may be classified into three categories according to a positional relationship, i.e., the eye corner key points, the upper eyelid key points, and the lower eyelid key points. The eye corner key points represent positions of corners of the eye in the eye image, and are the end points of the upper eyelid boundary and the lower eyelid boundary. Therefore, the computer device may connect the upper eyelid key points through the first connection line by using the eye corner key points as the end points, to obtain the upper eyelid boundary, and connect the lower eyelid key points through the second connection line by using the eye corner key points as the end points, to obtain the lower eyelid boundary, whereby the eyelid boundary may be determined based on the upper eyelid boundary and the lower eyelid boundary.

In another aspect, a manner of determining the eyelid boundary formed by the eyelid boundary key points may alternatively be sequentially connecting the eyelid boundary key points in a clockwise direction or an anticlockwise direction to form a convex polygon. The convex polygon is the eyelid boundary.

In this aspect, the manner for determining the eyelid boundary by connecting the key points is simple in processing manner, which can determine the position of the eyelid boundary quickly, and improve a data processing speed.

In some aspects, the operation of performing key point prediction on an eye image of a target object, to obtain a plurality of iris boundary key points and a plurality of eyelid boundary key points includes: key point prediction is performed on the eye image of the target object based on a key point prediction algorithm to obtain a plurality of pupil boundary key points, a plurality of outer iris boundary key points, and the plurality of eyelid boundary key points.

Further, the operation of performing contour fitting on the iris boundary key points according to an iris contour shape condition, to obtain a predicted iris area includes:
outer iris contour fitting is performed on the outer iris boundary key points based on a distribution of the outer iris boundary key points according to an outer iris contour shape condition, to obtain a predicted outer iris boundary; and pupil contour fitting is performed on the pupil boundary key points based on a distribution of the pupil boundary key points according to a pupil contour shape condition, to obtain a predicted pupil boundary; and the predicted iris area is determined by using the predicted outer iris boundary and the predicted pupil boundary as iris area boundaries.

The iris is an annular area located between a black pupil and a white sclera on a surface of a human eye. The iris boundary key points may be classified into two categories according to a positional relationship, namely, the pupil boundary key points and the outer iris boundary key points. The pupil boundary key points are key points located on a boundary line between the pupil and the iris, and the outer iris boundary key points are key points located on a boundary line between the iris and the sclera.

In a process of performing contour fitting on the iris boundary key points, the computer device may separately perform contour fitting on the pupil boundary key points and the outer iris boundary key points. The contour fitting of the pupil boundary key points and the contour fitting of the outer iris boundary key points may be performed synchronously or asynchronously, and may be determined according to an allocation state of a data processing resource.

For example, in an outer iris contour fitting process, the computer device performs outer iris contour fitting on the outer iris boundary key points based on the distribution of the outer iris boundary key points according to the outer iris contour shape condition, to obtain the predicted outer iris boundary. In a pupil contour fitting process, the computer device performs pupil contour fitting on the pupil boundary key points based on the distribution of the pupil boundary key points according to the pupil contour shape condition, to obtain the predicted pupil boundary. After obtaining the predicted outer iris boundary and the predicted pupil boundary, the computer device may determine an area between the predicted outer iris boundary and the predicted pupil boundary as the predicted iris area by using the predicted outer iris boundary and the predicted pupil boundary as the iris area boundaries based on a positional relationship between the predicted outer iris boundary and the predicted pupil boundary.

In this aspect, contour fitting is separately performed on the pupil boundary key points and the outer iris boundary key points, to obtain the predicted outer iris boundary and the predicted pupil boundary, whereby the iris boundary key points in different positions can be configured for implementing different iris boundary prediction, thereby improving the position accuracy of the predicted iris area.

The outer iris contour shape condition and the pupil contour shape condition may be different according to different shooting angles of the eye image and different environments. In some aspects, the outer iris contour shape condition is an elliptical contour. The pupil contour shape condition is a circular contour. Further, the operation of determining a predicted iris area by using the predicted outer iris boundary and the predicted pupil boundary as iris area boundaries includes:
the elliptical area formed by the predicted outer iris boundary and the circular area formed by the predicted pupil boundary are determined separately; and an area in the elliptical area not coinciding with the circular area is determined as the predicted iris area.

In an actual application process, to avoid occlusion for sight lines of the target object, the eye image of the target object may be acquired from an angle such as a side. In this case, due to angle distortion, the iris in the eye image of the target object presents an elliptical shape. Therefore, the outer iris boundary shape condition in the iris contour shape condition may be set to an elliptical contour, and the pupil boundary shape condition in the iris contour shape condition may be set to a circular contour.

In the outer iris contour fitting process, the computer device performs outer iris contour fitting on the outer iris boundary key points according to the elliptical contour based on the distribution of the outer iris boundary key points, to obtain an elliptical predicted outer iris boundary. In the pupil contour fitting process, the computer device performs pupil contour fitting on the pupil boundary key points according to the circular contour based on the distribution of the pupil boundary key points, to obtain a circular predicted pupil boundary. After obtaining the elliptical area formed by the predicted outer iris boundary and the circular area formed by the predicted pupil boundary, the computer device may determine the area in the elliptical area not coinciding with the circular area as the predicted iris area.

In this aspect, by considering impact of angle distortion on the outer iris boundary, the outer iris boundary shape condition in the iris contour shape condition may be set to an elliptical contour, whereby contour fitting for the outer iris boundary key points can be better implemented, and the accuracy for describing the pupil outer boundary by using the predicted outer iris boundary obtained through fitting is improved. Furthermore, considering that the pupil area is relatively small and less susceptible to distortion, to simplify fitting processing procedures in the pupil fitting process, the pupil boundary shape condition in the iris contour shape condition may be set to the circular contour, whereby a pupil boundary fitting speed can be effectively improved.

In some of the aspects, the operation of performing iris occlusion analysis on the target object based on a relative positional relationship between an area formed by the predicted iris area and an eyelid boundary to obtain an iris occlusion analysis result includes:
target pixels located in an area formed by the eyelid boundary are selected according to coordinates of each pixel for each pixel in the predicted iris area; an iris occlusion proportion of the target object is determined based on a proportion of a quantity of target pixels to a total quantity of pixels in the predicted iris area; and the iris occlusion analysis is performed based on the iris occlusion proportion and a maximum tolerance proportion threshold of iris occlusion to obtain the iris occlusion analysis result.

In an iris occlusion analysis process, the computer device employs a manner of calculating the proportion of the target pixels for analysis to ensure the accuracy of the iris occlusion analysis result. For example, the iris occlusion proportion of the target object is essentially a ratio result of target pixels in the area formed by the eyelid boundary in the predicted iris area to all pixels in the predicted iris area. A larger proportion of the quantity of target pixels to the total quantity of pixels in the predicted iris area indicates less iris occlusion, and a smaller proportion of the quantity of target pixels to the total quantity of pixels in the predicted iris area indicates more iris occlusion.

The maximum tolerance proportion threshold of iris occlusion is a threshold set when an iris occlusion degree affects subsequent processing. For example, eye image acquisition and iris occlusion analysis are performed on a target object wearing a VR device, to obtain an iris occlusion analysis result. When the iris occlusion analysis result is that the occlusion proportion exceeds the maximum tolerance proportion threshold, the iris occlusion analysis result is transmitted to the VR device, causing the VR device to transmit an eye-opening prompt message to the target object, to re-acquire the eye image for analysis. For another example, when the iris occlusion analysis result is that the occlusion proportion is less than or equal to the maximum tolerance proportion threshold, the server extracts an iris feature from the predicted iris area and performs iris recognition processing on the target object based on the iris feature, to obtain an iris recognition result.

Further, in some aspects, when the iris occlusion analysis result is that the iris occlusion proportion is less than or equal to the maximum tolerance proportion threshold of iris occlusion, an iris feature is extracted from the predicted iris area; and iris recognition processing is performed on the target object based on the iris feature to obtain a recognition result. In some other aspects, when the iris occlusion analysis result is that the iris occlusion proportion is greater than the maximum tolerance proportion threshold of iris occlusion, a prompt message for the target object is generated.

For example, the operation of generating a prompt message for the target object when the iris occlusion analysis result is that the iris occlusion proportion is greater than the maximum tolerance proportion threshold includes:
a prompt message type is determined based on a current scenario of the target object when the iris occlusion analysis result is that the iris occlusion proportion is greater than the maximum tolerance proportion threshold; and the prompt message is generated for the target object according to the prompt message type.

For example, the iris occlusion analysis method may be applied to a traffic scenario, an education scenario, or the like. For example, in a driving process of a driver in the traffic scenario, an iris occlusion analysis is performed on a driver by employing the foregoing iris occlusion analysis method, whether the driver is experiencing fatigue is determined according to an iris occlusion analysis result, and when the possible fatigue driving of the driver is detected, a prompt message is timely transmitted to the driver.

For another example, during the class in the education scenario, an iris occlusion analysis is performed on a student by employing the foregoing iris occlusion analysis method, whether the student is dozing off in class is determined according to an iris occlusion analysis result, and a prompt message is timely transmitted to the student when it is found that the student may be dozing off.

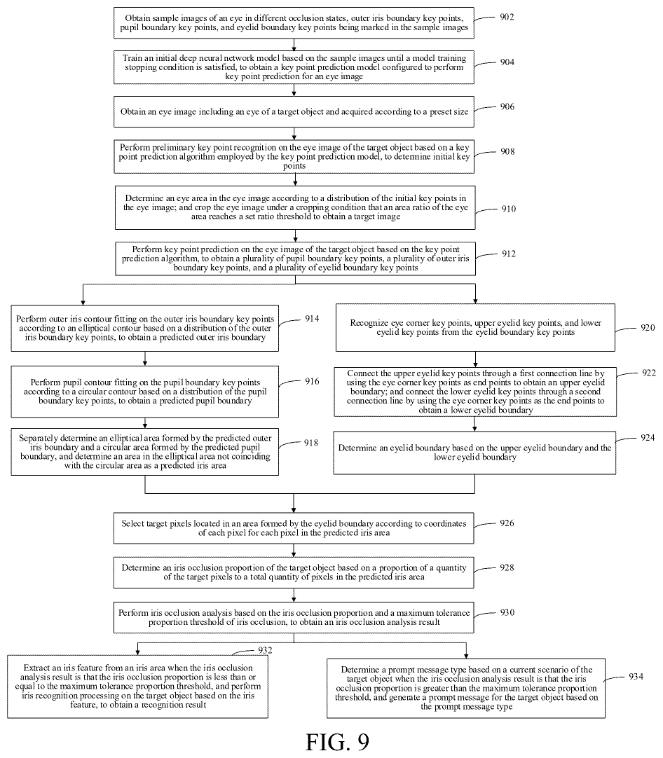

In some aspects, an iris occlusion analysis method is further provided, and as shown in FIG. 9, the method includes:

Operation 902: Obtain sample images of an eye in different occlusion states, outer iris boundary key points, pupil boundary key points, and eyelid boundary key points being marked in the sample images.

Operation 904: Train an initial deep neural network model based on the sample images until a model training stopping condition is satisfied, to obtain a key point prediction model configured to perform key point prediction for the eye image.

The sample image is sample data carrying eye key point marks, configured for training the key point prediction model. A manner of marking the key points in the sample image may affect a prediction effect of the trained key point prediction model. Therefore, when performing marking on the sample image, it is necessary to ensure that the distribution of the marked iris boundary key points in the sample image conforms to the iris contour shape condition, and the marked eyelid boundary key points are located on the eyelid boundary, causing the marked eyelid boundary key points to accurately represent the eyelid boundary in the sample image. A manner of marking the key points in the sample image may be implemented based on types of the key points. For example, the iris boundary key points may be selected from an iris contour with a particular shape in the sample image, and the eyelid boundary key points may be directly selected from the eyelid boundary in the sample image.

The initial deep neural network model may be a deep neural network (DNN) model. The DNN model includes a plurality of convolutional layers and two fully-connected layers. After obtaining the predicted target points from the fully-connected layers, a current image is further cropped based on the predicted target points, to obtain a new image which is processed by the DNN model for target point prediction until a target image with key point distribution satisfying a distribution condition is obtained. Then, the DNN model performs final key point prediction processing on the target image to output a prediction result. In a training process, the DNN model employs supervised training implemented based on the marked key points, to obtain the key point prediction model through training for performing key point prediction processing on the eye image of the target object.

Operation 906: Obtain an eye image including an eye of a target object and acquired according to a preset size.

The acquisition of the eye image includes: the computer device transmits an acquisition instruction to an image acquisition apparatus, and obtains the eye image including the eye of the target object and acquired by the image acquisition apparatus according to the preset size. In another aspect, the acquisition of the eye image may alternatively be that the image acquisition apparatus actively triggers eye image acquisition for the target object when detecting that a particular condition is satisfied, and transmits the acquired eye image to the computer device. The image acquisition apparatus may be a device communicating with the computer device over a network, or an apparatus built in the computer device. In some aspects, for example, in a VR scenario, the image acquisition apparatus may be an infrared image acquisition apparatus. The infrared image acquisition apparatus acquires broad-spectrum infrared imaging by employing an infrared sensor. Since an iris has unique infrared absorption characteristics, and interference of VR color imaging in the VR scenario needs to be avoided, employing the infrared image to acquire the iris information has good anti-interference and recognition effect.

Operation 908: Perform preliminary key point recognition on the eye image of the target object based on a key point prediction algorithm employed by the key point prediction model, to determine initial key points. For example, preliminary key point recognition is performed on the eye image of the target object to determine initial key points.

Operation 910: Determine an eye area in the eye image according to a distribution of the initial key points in the eye image; and crop the eye image under a cropping condition that an area ratio of the eye area reaches a set ratio threshold, to obtain a target image. For example, an eye area in the eye image is determined based on a distribution of the initial key points. The eye image is cropped under a cropping condition that an area ratio of the eye area reaches a ratio threshold to obtain a target image.

Operation 912: Perform key point prediction on the eye image of the target object, to obtain a plurality of pupil boundary key points, a plurality of outer iris boundary key points, and a plurality of eyelid boundary key points. For example, a plurality of pupil boundary key points, a plurality of outer iris boundary key points, and the plurality of eyelid boundary key points are obtained. The plurality of pupil boundary key points and the plurality of outer iris boundary key points form the plurality of iris boundary key points.

Operation 914: Perform outer iris contour fitting on the outer iris boundary key points according to an elliptical contour based on a distribution of the outer iris boundary key points, to obtain a predicted outer iris boundary. For example, outer iris contour fitting is performed on the plurality of outer iris boundary key points based on an outer iris contour shape condition based on a distribution of the outer iris boundary key points, to obtain a predicted outer iris boundary.

Operation 916: Perform pupil contour fitting on the pupil boundary key points according to a circular contour based on a distribution of the pupil boundary key points, to obtain a predicted pupil boundary. For example, pupil contour fitting is performed on the plurality of pupil boundary key points based on a pupil contour shape condition based on a distribution of the pupil boundary key points, to obtain a predicted pupil boundary.

Operation 918: Separately determine an elliptical area formed by the predicted outer iris boundary and a circular area formed by the predicted pupil boundary, and determine an area in the elliptical area not coinciding with the circular area as a predicted iris area. For example, an elliptical area formed by the predicted outer iris boundary and a circular area formed by the predicted pupil boundary are separately determined. An area in the elliptical area that does not coincide with the circular area is determined as the predicted iris area.

Operation 920: Recognize eye corner key points, upper eyelid key points, and lower eyelid key points from the eyelid boundary key points. For example, the eye corner key points, the upper eyelid key points, and the lower eyelid key points from the plurality of eyelid boundary key points are recognized.

Operation 922: Connect the upper eyelid key points through a first connection line by using the eye corner key points as end points to obtain an upper eyelid boundary; and connect the lower eyelid key points through a second connection line by using the eye corner key points as the end points to obtain a lower eyelid boundary. For example, the upper eyelid key points are connected through a first connection line using the eye corner key points as end points, to obtain the upper eyelid boundary. The lower eyelid key points are connected through a second connection line using the eye corner key points as the end points, to obtain the lower eyelid boundary.

Operation 924: Determine an eyelid boundary based on the upper eyelid boundary and the lower eyelid boundary. For example, the eyelid boundary is determined based on the upper eyelid boundary and the lower eyelid boundary.

Operation 926: Select target pixels located in an area formed by the eyelid boundary according to coordinates of each pixel for each pixel in the predicted iris area. For example, target pixels located in the area formed by the eyelid boundary are selected based on coordinates of each pixel in the predicted iris area.

Operation 928: Determine an iris occlusion proportion of the target object based on a proportion of a quantity of the target pixels to a total quantity of pixels in the predicted iris area. For example, an iris occlusion proportion of the target object is determined based on a proportion of the target pixels to a total quantity of pixels in the predicted iris area.

Operation 930: Perform iris occlusion analysis based on the iris occlusion proportion and a maximum tolerance proportion threshold of iris occlusion, to obtain an iris occlusion analysis result. For example, iris occlusion analysis is performed based on the iris occlusion proportion and a maximum tolerance proportion threshold of iris occlusion, to obtain the iris occlusion analysis result.

Operation 932: Extract an iris feature from the predicted iris area when the iris occlusion analysis result is that the iris occlusion proportion is less than or equal to a maximum tolerance proportion threshold, and perform iris recognition processing on the target object based on the iris feature, to obtain a recognition result. For example, an iris feature from the predicted iris area is extracted when the iris occlusion analysis result indicates that the iris occlusion proportion is less than or equal to the maximum tolerance proportion threshold. Iris recognition processing is performed on the target object based on the iris feature to obtain an iris recognition result.

Operation 934: Determine a prompt message type based on a current scenario of the target object when the iris occlusion analysis result is that the iris occlusion proportion is greater than the maximum tolerance proportion threshold, and generate a prompt message for the target object according to the prompt message type. For example, a prompt message for the target object is generated when the iris occlusion analysis result indicates that the iris occlusion proportion is greater than the maximum tolerance proportion threshold. In another example, a prompt message type is determined based on a current scenario of the target object. The prompt message is generated based on the prompt message type.

This disclosure further provides an application scenario of VR iris recognition. The application scenario employs the aforementioned iris occlusion analysis method. For example, an application of the iris occlusion analysis method in the application scenario is as follows:

In an iris recognition scenario, due to different eye sizes of users, there may be different degrees of eyelid occlusion. Based on this, a related processing method needs to be provided to determine iris occlusion by eyelids, to ensure an iris recognition effect. In the related art, the iris occlusion determining algorithm is mainly to determine iris occlusion after performing semantic segmentation on the eyelids and the iris. The semantic segmentation-based method has relatively high requirements on the accuracy and speed of segmentation algorithms, thereby having relatively low speed in the VR recognition scenario, and failing to implement real-time processing. Furthermore, based on the semantic segmentation, only content areas of the iris and eyelids can be obtained, and an iris occlusion proportion cannot be determined. Due to a difference in camera imaging distances, the occlusion proportion cannot be evaluated even when a size of an iris area is obtained. In addition, due to interference factors such as an eyelid shadow and eyelashes for iris recognition in the VR scenario, semantic segmentation accuracy may be low.

In this application, after a user wears the VR device, an iris recognition camera may continuously acquire an eye picture of the user. An iris occlusion state of the user is determined through an algorithm for corresponding prompting, and the user is prompted to open eyes or adjust displayed content if the occlusion proportion is relatively large to guide the user to open eyes. For example, after predicting the eyelid boundary key points and the iris boundary key points through the DeepPose algorithm, the computer device may determine the iris occlusion proportion based on a positional relationship of the eyelid key points, the pupil, and the iris.

For example, this solution mainly includes three parts:

1. The pupil boundary key points, the outer iris boundary key points, and the eyelid boundary key points are calculated based on the DeepPose algorithm.

2. The iris area formed by the pupil boundary and the outer iris boundary is determined based on the pupil boundary key points, the outer iris boundary key points, and the eyelid boundary key points, and the iris occlusion proportion is calculated accurately based on the eyelid boundary.

3. Whether the occlusion proportion meets a requirement is preferably determined logically, and a corresponding prompt is provided.

Further, the iris occlusion is calculated on the premise that the position information of the iris and the position information of the eyelids need to be known, whereby an occlusion proportion can be correctly calculated, and the occlusion degree can be determined to evaluate whether subsequent algorithms such as iris recognition support occlusion of this degree. Regarding the position information of the iris area, key point prediction may be performed by using the DeepPose algorithm, and the predicted iris area is obtained based on the predicted key points.

The idea of the DeepPose algorithm is to transform the key point detection algorithm to a pure mathematical prediction problem without considering an ergonomic problem in a complex posture. A large amount of human eye key point data in various postures is manually marked, and sample data is learned by using a DNN convolutional neural network, to implement a more generalized end-to-end eye key point detection algorithm.

In a first stage of eye key point detection, the DNN convolutional neural network may perform a series of convolutions on an inputted image of a set size, and finally obtain coordinates (xi, yi) of a predicted key point by using two full link layers. Furthermore, an optimization idea of the DeepPose algorithm is that since an inputted target size is uncertain, and the network only receives an inputted image of a fixed size, the excessively large image may lead to a deviation in the final key point prediction due to zooming. In a second stage of eye key point detection, the DeepPose algorithm continues to reuse the idea of the first stage, but crops and enlarges a surrounding area of the predicted key point position for further more accurate prediction, thereby improving the final prediction accuracy. The DeepPose algorithm is to perform fitting on a nonlinear regression problem by employing the DNN, and return a network prediction result from end to end.

In an aspect, taking analysis on an eye image of a right eye of a target object as an example, the eye image is predicted by employing a DeepPose algorithm to return 19 key points of an eye area, including 4 estimated key points for eyelid key points, 8 estimated key points for points around an iris, and 7 estimated key points for points around a pupil. For example, since the pupil is inherently a circular area, and in a scenario of iris recognition, ambient adaptation causes pupil constriction, and an imaging distortion remains relatively small at minor angles. Therefore, only four key points are used for pupil key points. The iris area is larger than the pupil, and an upper right side of the iris area is more likely to be occluded by the eyelid, and therefore, eight key points are employed for registration in the iris area. Similarly, an upper portion of the eyelid area has a larger curvature than that of a lower portion of the eyelid area, and therefore, more key points (7 key points) are employed for registration for the upper key points.

Based on the iris boundary key points, the pupil area and the iris area may be changed from circular areas to elliptical areas due to distortions such as the angle. However, the pupil area is relatively small and is slightly affected by the distortion, and more registration points may lead to a larger deviation, whereby for the pupil area, four points are employed to determine a circular marked pupil area. Eight points on an iris edge are employed to perform elliptical matching in cooperation with an elliptical fitting function fitEllipse of opencv (a cross-platform computer vision library), to obtain position information of the iris area. Due to an irregular shape of the eyelid boundary, a simple connection method may be employed to calibrate the eyelid boundary.

For example, the computer device performs fitting on the four pupil boundary key points to obtain a circular pupil boundary, and performs fitting on the eight outer iris boundary key points to obtain an elliptical outer iris boundary. The predicted iris area is determined based on the fitted outer iris boundary and the fitted pupil boundary. Further, the computer device connects the two eye corner key points and the three upper eyelid boundary key points to obtain the upper eyelid boundary, connects the two eye corner key points and the one lower eyelid boundary key point to obtain the lower eyelid boundary, and then determines the eyelid boundary based on the upper eyelid boundary and the lower eyelid boundary.

The iris area may be determined through the known pupil boundary and the outer iris boundary. The computer device determines whether each pixel in the iris area is located in an area formed by the upper eyelid boundary and the lower eyelid boundary, thereby accurately determining the iris occlusion proportion.

The iris occlusion proportion is determined through the iris recognition algorithm. If the occlusion proportion is greater than the maximum tolerance proportion of the iris recognition algorithm, eyes are prompted to be opened; and otherwise, if the iris occlusion proportion meets the requirement of the iris recognition algorithm, subsequent iris recognition processing is performed based on the iris recognition algorithm.

In this aspect, because the implementation of this solution is mainly to predict the iris key points based on the DeepPose algorithm, the algorithm speed is relatively high. For the iris recognition in the VR scenario, the iris occlusion may be determined accurately while ensuring the recognition speed, whereby the problems of the traditional semantic segmentation-based algorithm such as low speed, and incorrect calculation of the occlusion proportion can be resolved.

Although the operations are displayed sequentially according to instructions of arrows in the flowcharts involved in various foregoing aspects, these operations are not necessarily performed sequentially according to the sequence instructed by the arrows. Unless otherwise explicitly specified in this disclosure, execution of the operations is not strictly limited, and the operations may be performed in other sequences. Moreover, at least some of the operations in the flowcharts involved in various foregoing aspects may include a plurality of operations or a plurality of stages. The operations or stages are not necessarily performed at the same moment but may be performed at different moments. The operations or stages are not necessarily sequentially performed, but may be performed alternately with other operations or at least some operations or stages of other operations.

Based on the same inventive concept, an aspect of this disclosure further provides an iris occlusion analysis apparatus for implementing the foregoing iris occlusion analysis method. The implementation solution provided by the apparatus is similar to the implementation solution recorded in the foregoing method. Therefore, for specific limitations to one or more iris occlusion analysis apparatus aspects provided below, refer to the limitations to the foregoing iris occlusion analysis method. Details are not described herein again.

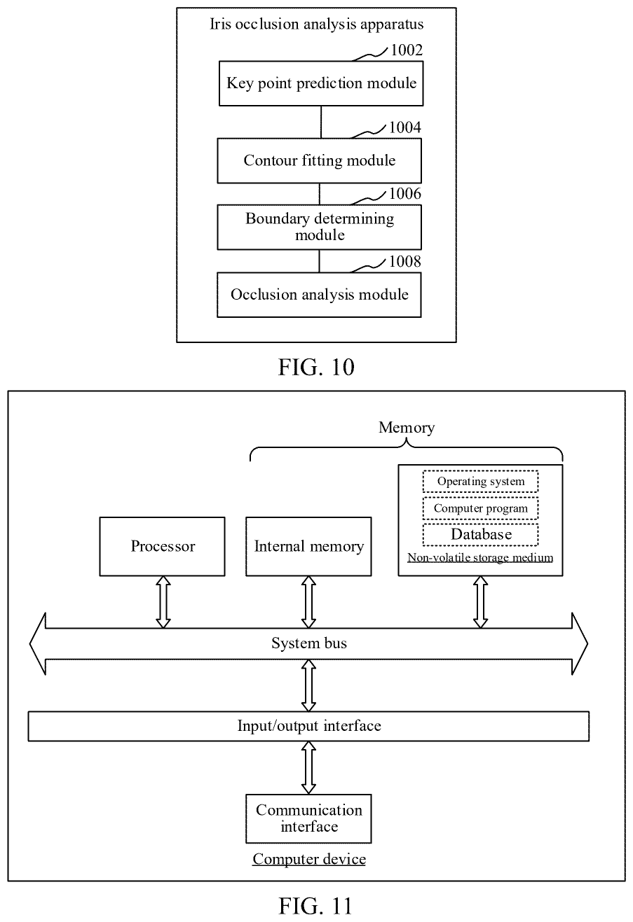

In an aspect, as shown in FIG. 10, an iris occlusion analysis apparatus is provided, including a key point prediction module 1002, a contour fitting module 1004, a boundary determining module 1006, and an occlusion analysis module 1008, where
the key point prediction module 1002 is configured to perform key point prediction on an eye image of a target object, to obtain a plurality of iris boundary key points and a plurality of eyelid boundary key points;
the contour fitting module 1004 is configured to perform contour fitting on the iris boundary key points according to an iris contour shape condition, to obtain a predicted iris area;
the boundary determining module 1006 is configured to determine an eyelid boundary formed by the eyelid boundary key points; and
the occlusion analysis module 1008 is configured to perform iris occlusion analysis on the target object based on a relative positional relationship between the predicted iris area and an area formed by the eyelid boundary to obtain an iris occlusion analysis result.

In some of the aspects, the key point prediction module is further configured to perform preliminary key point recognition on the eye image of the target object, to determine initial key points; determine an eye area in the eye image according to a distribution of the initial key points in the eye image; crop the eye image under a cropping condition that an area ratio of the eye area reaches a set ratio threshold, to obtain a target image; and perform key point prediction on the target image based on a key point prediction algorithm, to obtain the plurality of iris boundary key points and the plurality of eyelid boundary key points.

In some of the aspects, the key point prediction process is implemented by a key point prediction model; and a training process of the key point prediction model includes:
sample images of an eye in different occlusion states are obtained, iris boundary key points and eyelid boundary key points are marked in the sample images, and a distribution of the marked iris boundary key points in each sample image conforms to the iris contour shape condition; the marked eyelid boundary key points are configured for representing an eyelid boundary in each sample image; and an initial deep neural network model is trained based on the sample images until a model training stopping condition is satisfied, to obtain the key point prediction model configured to perform key point prediction on the eye image.

In some of the aspects, the eyelid boundary includes an upper eyelid boundary and a lower eyelid boundary; the eyelid boundary key points include eye corner key points located at intersections of the upper eyelid boundary and the lower eyelid boundary, upper eyelid key points located on the upper eyelid boundary, and lower eyelid key points located on the lower eyelid boundary; and a quantity of the upper eyelid key points is greater than a quantity of the lower eyelid key points.

In some of the aspects, the boundary determining module is further configured to recognize the eye corner key points, the upper eyelid key points, and the lower eyelid key points from the eyelid boundary key points; connect the upper eyelid key points through a first connection line by using the eye corner key points as end points to obtain the upper eyelid boundary; connect the lower eyelid key points through a second connection line by using the eye corner key points as the end points to obtain the lower eyelid boundary; and determine the eyelid boundary based on the upper eyelid boundary and the lower eyelid boundary.

In some of the aspects, the key point prediction module is further configured to perform key point prediction on the eye image of the target object, to obtain a plurality of pupil boundary key points, a plurality of outer iris boundary key points, and a plurality of eyelid boundary key points; and
the contour fitting module is further configured to perform outer iris contour fitting on the outer iris boundary key points according to an outer iris contour shape condition based on a distribution of the outer iris boundary key points, to obtain a predicted outer iris boundary; perform pupil contour fitting on the pupil boundary key points according to a pupil contour shape condition based on a distribution of the pupil boundary key points, to obtain a predicted pupil boundary; and determine the predicted iris area by using the predicted outer iris boundary and the predicted pupil boundary as iris area boundaries.

In some of the aspects, the outer iris contour shape condition is an elliptical contour; and the pupil contour shape condition is a circular contour; and
the contour fitting module is further configured to separately determine an elliptical area formed by the predicted outer iris boundary and a circular area formed by the predicted pupil boundary; and determine an area in the elliptical area not coinciding with the circular area as the predicted iris area.

In some of the aspects, the occlusion analysis module is further configured to select target pixels located in the area formed by the eyelid boundary according to coordinates of each pixel for each pixel in the predicted iris area; determine an iris occlusion proportional of the target object based on a proportion of a quantity of target pixels to a total quantity of pixels in the predicted iris area; and perform iris occlusion analysis based on the iris occlusion proportion and a maximum tolerance proportion threshold of iris occlusion to obtain the iris occlusion analysis result.

In some of the aspects, the apparatus further includes an iris recognition module, configured to extract an iris feature from the predicted iris area when the iris occlusion analysis result is that the iris occlusion proportion is less than or equal to the maximum tolerance proportion threshold of iris occlusion; and perform iris recognition processing on the target object based on the iris feature to obtain a recognition result.

In some of the aspects, the apparatus further includes a message generating module, configured to generate a prompt message for the target object when the iris occlusion analysis result is that the iris occlusion proportion is greater than the maximum tolerance proportion threshold of iris occlusion.

In some of the aspects, the message generating module is further configured to determine a prompt message type based on a current scenario of the target object when the iris occlusion analysis result is that the iris occlusion proportion is greater than the maximum tolerance proportion threshold of iris occlusion; and generate the prompt message for the target object according to the prompt message type.

According to the foregoing iris occlusion analysis apparatus, the key point prediction is performed on the eye image of the target object, whereby the plurality of iris boundary key points and the plurality of eyelid boundary key points may be directly predicted, and the key points in the eye image can be quickly predicted, whereby the predicted iris area and the eyelid boundary can be determined based on the key points. The predicted iris area is not just an iris shown in the eye image, but is obtained by performing contour fitting on the iris boundary key points according to the iris contour shape condition. The predicted iris area can be conveniently and quickly determined. The eyelid boundary is formed by the eyelid boundary key points and can accurately express an eyelid position in the eye image, whereby the iris occlusion analysis can be performed on the target object based on the relative positional relationship between the predicted iris area and the area formed by the eyelid boundary, to quickly and accurately obtain the iris occlusion analysis result.

All the modules in the iris occlusion analysis apparatus may be implemented through software, hardware, or any combination thereof. The foregoing modules may be embedded in or may be independent from a processor in a computer device in a hardware form, or may be stored in a memory in the computer device in a software form, to facilitate the processor to perform the operations corresponding to each module.

In an aspect, a computer device is provided. The computer device may be a server, and an internal structure of the computer device may be shown in FIG. 11. The computer device includes a processor, a memory, an input/output (I/O) interface, and a communication interface. The processor, the memory, and the I/O interface are connected through a system bus, and the communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an operating environment for running the operating system and the computer program in the non-volatile storage medium. The database of the computer device is configured to store data. The input/output interface of the computer device is configured to exchange information between the processor and peripheral equipment. The communication interface of the computer device is configured to connect and communicate with an external terminal over a network. The computer program is executed by the processor to implement the iris occlusion analysis method.

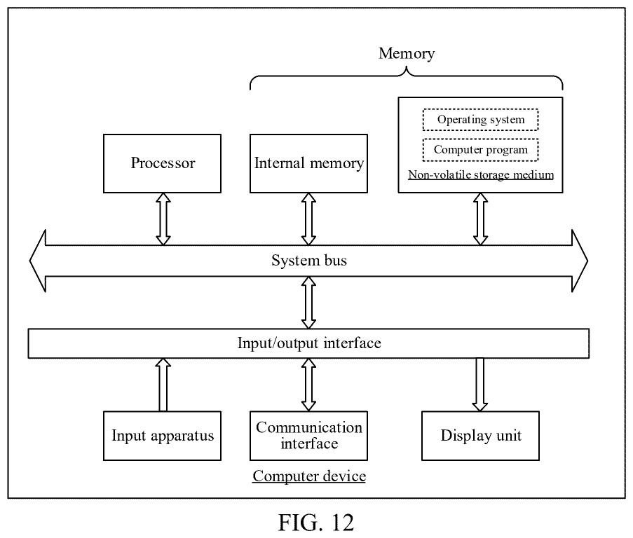

In an aspect, a computer device is provided. The computer device may be a terminal, and an internal structure diagram of the computer device may be shown in FIG. 12. The computer device includes a processor, a memory, an input/output interface, a communication interface, a display unit, and an input apparatus. The processor, the memory, and the input/output interface are connected by a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and a computer program. The internal memory provides an operating environment for running the operating system and the computer program in the non-volatile storage medium. The input/output interface of the computer device is configured to exchange information between the processor and peripheral equipment. The communication interface of the computer device is configured to communicate with external terminals in a wired way or a wireless way, and the wireless way may be implemented by WI-FI, mobile cellular networks, near-field communication (NFC) or other technologies. The computer program is executed by the processor to implement the iris occlusion analysis method. The display unit of the computer device is configured to form a visually visible picture, and may be a display screen, a projection apparatus, or a virtual reality imaging apparatus. The display screen may be a liquid crystal display screen or an electronic-ink display screen. The input apparatus of the computer device may be a touch layer covering the display screen, may be a key, a trackball, or a touch pad arranged on a housing of the computer device, or may be an external keyboard, a touch pad, mouse, etc.

It is noted that the structures shown in FIG. 11 and FIG. 12 are merely examples of block diagrams of a partial structure related to a solution in this disclosure, and do not constitute a limitation to the computer device to which the solution in the disclosure is applied. For example, the computer device may include more components or fewer components than those shown in the figure, or some components may be combined, or a different component deployment may be used.

An aspect further provides a computer device. The computer device includes a memory and a processor. The memory stores a computer program. The processor executes the computer program to perform the operations of the foregoing method aspects.

An aspect provides a computer-readable storage medium, such as a non-transitory computer-readable storage medium. The computer-readable storage medium has a computer program stored therein. The computer program is executed by a processor to perform the operations of the foregoing method aspects.

An aspect provides a computer program product. The computer program product includes a computer program. The computer program is executed by a processor to perform the operations of the foregoing method aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

A person of ordinary skill in the art may understand that all or some of procedures of the method in the foregoing aspects may be implemented by a computer program instructing relevant hardware. The program may be stored in a non-volatile computer-readable storage medium. When the program is executed, the procedures of the foregoing method aspects may be implemented. Any reference to a memory, a database, or another medium used in the aspects provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM) or an external cache. As illustration rather than limitation, the RAM may be in various forms, such as a static random access memory (SRAM), or a dynamic random access memory (DRAM). The database involved in the aspects provided in this disclosure may include at least one of a relational database and a non-relational database. The non-relational database may include a block chain-based distributed database, or the like, but is not limited thereto. Processing circuitry, such as the processor involved in the aspects provided in this disclosure, may be a general-purpose processor, a central processing unit, a graphics processing unit, a digital signal processor, a programmable logic device, a quantum computing-based data processing logic device, or the like, but is not limited thereto.

Technical features of the foregoing aspects may be combined in various manners. To make description concise, not all possible combinations of the technical features in the foregoing aspects are described. However, the combinations of these technical features shall be considered as falling within the scope recorded by this specification provided that no conflict exists.

The foregoing aspects show only several implementations of this disclosure and are described in detail, which, however, are not to be construed as a limitation to the scope of this disclosure. Several transformations and improvements can be made without departing from the idea of this disclosure. These transformations and improvements belong to the scope of this disclosure.

What is claimed is:

1. A method for iris occlusion analysis, the method comprising:
performing key point prediction on an eye image of a target object to obtain a plurality of iris boundary key points and a plurality of eyelid boundary key points;
performing contour fitting on the plurality of iris boundary key points based on an iris contour shape condition to obtain a predicted iris area;
determining an eyelid boundary formed by the plurality of eyelid boundary key points; and
performing the iris occlusion analysis on the target object based on a relative positional relationship between the predicted iris area and an area formed by the eyelid boundary to obtain an iris occlusion analysis result.

2. The method according to claim 1, wherein the performing the key point prediction on the eye image of the target object comprises:
performing preliminary key point recognition on the eye image of the target object to determine initial key points;
determining an eye area in the eye image based on a distribution of the initial key points;
cropping the eye image under a cropping condition that an area ratio of the eye area reaches a ratio threshold to obtain a target image; and
performing the key point prediction on the target image based on a key point prediction model, to obtain the plurality of iris boundary key points and the plurality of eyelid boundary key points.

3. The method according to claim 1, wherein the key point prediction is performed using a key point prediction model trained on sample images of eyes in different occlusion states, the sample images including iris boundary key points and eyelid boundary key points marked to indicate corresponding boundaries.

4. The method according to claim 1, wherein
the eyelid boundary includes an upper eyelid boundary and a lower eyelid boundary;
the plurality of eyelid boundary key points includes:
eye corner key points located at intersections of the upper eyelid boundary and the lower eyelid boundary,
upper eyelid key points located on the upper eyelid boundary, and
lower eyelid key points located on the lower eyelid boundary; and
a quantity of the upper eyelid key points is greater than a quantity of the lower eyelid key points.

5. The method according to claim 4, wherein the determining the eyelid boundary comprises:
recognizing the eye corner key points, the upper eyelid key points, and the lower eyelid key points from the plurality of eyelid boundary key points;
connecting the upper eyelid key points through a first connection line using the eye corner key points as end points, to obtain the upper eyelid boundary;
connecting the lower eyelid key points through a second connection line using the eye corner key points as the end points, to obtain the lower eyelid boundary; and
determining the eyelid boundary based on the upper eyelid boundary and the lower eyelid boundary.

6. The method according to claim 1, wherein the performing the key point prediction comprises:
obtaining
(i) a plurality of pupil boundary key points;
(ii) a plurality of outer iris boundary key points, the plurality of pupil boundary key points and the plurality of outer iris boundary key points forming the plurality of iris boundary key points; and
(iii) the plurality of eyelid boundary key points; and
the performing the contour fitting comprises:
performing outer iris contour fitting on the plurality of outer iris boundary key points based on an outer iris contour shape condition based on a distribution of the plurality of outer iris boundary key points, to obtain a predicted outer iris boundary;
performing pupil contour fitting on the plurality of pupil boundary key points based on a pupil contour shape condition based on a distribution of the plurality of pupil boundary key points, to obtain a predicted pupil boundary; and
determining the predicted iris area by using the predicted outer iris boundary and the predicted pupil boundary as iris area boundaries.

7. The method according to claim 6, wherein
the outer iris contour shape condition is an elliptical contour;
the pupil contour shape condition is a circular contour; and
the determining the predicted iris area comprises:
separately determining an elliptical area formed by the predicted outer iris boundary and a circular area formed by the predicted pupil boundary; and
determining an area in the elliptical area that does not coincide with the circular area as the predicted iris area.

8. The method according to claim 1, wherein the performing the iris occlusion analysis comprises:
selecting target pixels located in the area formed by the eyelid boundary based on coordinates of each pixel in the predicted iris area;
determining an iris occlusion proportion of the target object based on a proportion of the target pixels to a total quantity of pixels in the predicted iris area; and
performing the iris occlusion analysis based on the iris occlusion proportion and a maximum tolerance proportion threshold of iris occlusion, to obtain the iris occlusion analysis result.

9. The method according to claim 8, further comprising:
extracting an iris feature from the predicted iris area when the iris occlusion analysis result indicates that the iris occlusion proportion is less than or equal to the maximum tolerance proportion threshold; and
performing iris recognition processing on the target object based on the iris feature to obtain an iris recognition result.

10. The method according to claim 8, further comprising:
generating a prompt message for the target object when the iris occlusion analysis result indicates that the iris occlusion proportion is greater than the maximum tolerance proportion threshold.

11. The method according to claim 10, wherein the generating the prompt message comprises:
determining a prompt message type based on a current scenario of the target object; and
generating the prompt message based on the prompt message type.

12. An iris occlusion analysis apparatus, comprising:
processing circuitry configured to:
perform key point prediction on an eye image of a target object to obtain a plurality of iris boundary key points and a plurality of eyelid boundary key points;
perform contour fitting on the plurality of iris boundary key points based on an iris contour shape condition to obtain a predicted iris area;
determine an eyelid boundary formed by the plurality of eyelid boundary key points; and
perform iris occlusion analysis on the target object based on a relative positional relationship between the predicted iris area and an area formed by the eyelid boundary to obtain an iris occlusion analysis result.

13. The apparatus according to claim 12, wherein the processing circuitry is configured to:
perform preliminary key point recognition on the eye image of the target object to determine initial key points;
determine an eye area in the eye image based on a distribution of the initial key points;
crop the eye image under a cropping condition that an area ratio of the eye area reaches a ratio threshold to obtain a target image; and
perform the key point prediction on the target image based on a key point prediction model, to obtain the plurality of iris boundary key points and the plurality of eyelid boundary key points.

14. The apparatus according to claim 12, wherein the key point prediction is performed using a key point prediction model trained on sample images of eyes in different occlusion states, the sample images including iris boundary key points and eyelid boundary key points marked to indicate corresponding boundaries.

15. The apparatus according to claim 12, wherein
the eyelid boundary includes an upper eyelid boundary and a lower eyelid boundary;
the plurality of eyelid boundary key points includes:
eye corner key points located at intersections of the upper eyelid boundary and the lower eyelid boundary,
upper eyelid key points located on the upper eyelid boundary, and
lower eyelid key points located on the lower eyelid boundary; and
a quantity of the upper eyelid key points is greater than a quantity of the lower eyelid key points.

16. The apparatus according to claim 15, wherein the processing circuitry is configured to:
recognize the eye corner key points, the upper eyelid key points, and the lower eyelid key points from the plurality of eyelid boundary key points;
connect the upper eyelid key points through a first connection line using the eye corner key points as end points, to obtain the upper eyelid boundary;
connect the lower eyelid key points through a second connection line using the eye corner key points as the end points, to obtain the lower eyelid boundary; and
determine the eyelid boundary based on the upper eyelid boundary and the lower eyelid boundary.

17. The apparatus according to claim 12, wherein the processing circuitry is configured to:
obtain
(i) a plurality of pupil boundary key points;
(ii) a plurality of outer iris boundary key points, the plurality of pupil boundary key points and the plurality of outer iris boundary key points forming the plurality of iris boundary key points; and
(iii) the plurality of eyelid boundary key points; and
the processing circuitry is further configured to:
perform outer iris contour fitting on the plurality of outer iris boundary key points based on an outer iris contour shape condition based on a distribution of the plurality of outer iris boundary key points, to obtain a predicted outer iris boundary;
perform pupil contour fitting on the plurality of pupil boundary key points based on a pupil contour shape condition based on a distribution of the plurality of pupil boundary key points, to obtain a predicted pupil boundary; and
determine the predicted iris area by using the predicted outer iris boundary and the predicted pupil boundary as iris area boundaries.

18. The apparatus according to claim 17, wherein
the outer iris contour shape condition is an elliptical contour;
the pupil contour shape condition is a circular contour; and
the processing circuitry is configured to:
separately determine an elliptical area formed by the predicted outer iris boundary and a circular area formed by the predicted pupil boundary; and
determine an area in the elliptical area that does not coincide with the circular area as the predicted iris area.

19. The apparatus according to claim 12, wherein the processing circuitry is configured to:
select target pixels located in the area formed by the eyelid boundary based on coordinates of each pixel in the predicted iris area;
determine an iris occlusion proportion of the target object based on a proportion of the target pixels to a total quantity of pixels in the predicted iris area; and
perform the iris occlusion analysis based on the iris occlusion proportion and a maximum tolerance proportion threshold of iris occlusion, to obtain the iris occlusion analysis result.

20. A non-transitory computer-readable storage medium storing instructions which, when executed by a processor, cause the processor to perform:
performing key point prediction on an eye image of a target object to obtain a plurality of iris boundary key points and a plurality of eyelid boundary key points;
performing contour fitting on the plurality of iris boundary key points based on an iris contour shape condition to obtain a predicted iris area;
determining an eyelid boundary formed by the plurality of eyelid boundary key points; and
performing iris occlusion analysis on the target object based on a relative positional relationship between the predicted iris area and an area formed by the eyelid boundary to obtain an iris occlusion analysis result.
